(19) United States
(12) Patent Application Publication
(10) Pub. No.: US 2013/0026310 A1
(43) Pub. Date: Jan. 31, 2013

(54) MOBILE STAND FOR INTERACTIVE SURFACES

(71) Applicant: KAYLYN BELCOURT-McCABE, Kenilworth (CA)

(72) Inventor: KAYLYN BELCOURT-McCABE, Kenilworth (CA)

(73) Assignee: COPERNICUS EDUCATIONAL PRODUCTS INC., Arthur (CA)

(21) Appl. No.: 13/560,417

(22) Filed: Jul. 27, 2012

Related U.S. Application Data
(60) Provisional application No. 61/457,985, filed on Jul. 28, 2011.

(51) Int. Cl. G03B 21/54

(52) U.S. Cl. 248/125.1; 248/122.1

(57) ABSTRACT

The present invention relates to an interactive projector mobile apparatus for use as an interactive projector system. The interactive projector apparatus comprises a rotatable projector mount for mounting a projector. The projector may be used to project images on a vertical or horizontal surface. The interactive projector mobile apparatus may also comprise a moveable column on which the projector is mounted. This allows the projector to be moved to different positions.

### RELATED APPLICATION

The present application claims the benefit under 35 U.S.C. §119(e) of U.S. Provisional Patent Application Ser. No. 61/457,985 filed Jul. 28, 2011 and entitled MOBILE STAND FOR INTERACTIVE WORK SURFACES. The above mentioned provisional application is incorporated herein in its entirety.

### FIELD OF THE INVENTION

The present invention relates to an apparatus for mounting a projector for projecting an image onto both horizontal and vertical surfaces to create interactive displays. More particularly, the invention relates to a mobile stand for mounting a projector for projection of an image onto the floor/ground (horizontal), table top (horizontal) or wall (vertical) surfaces through the mounting of a rotatable, interactive projector and computer on the stand.

### BACKGROUND

There are many interactive display systems currently in use for projecting images onto vertical surfaces such as walls, screens and whiteboards. These systems typically consist of a projector and projector mount interfaced with a computer. These systems may be particularly useful in educational and teaching environments.

There have been attempts to adapt the technology used for vertical projection systems and touch screen technologies to create interactive displays on table tops. However, there have not been many attempts to develop an apparatus that can project onto both horizontal and vertical surfaces. Problems associated with prior attempts to develop a practical and cost effective system that have particular application in schools include:

Flexibility—For horizontal projection systems, commonly the projector and table are provided as a unit and the projector is mounted permanently on, under or above the table. This limits the image size and portability of the system. In these systems, image size may be limited since it cannot be any larger than what the table and the mount allow. Also, portability within an environment is limited. For example, even if the table folds for moving through a doorway, the entire system is large and bulky and would not fit in an elevator or could not be carried up stairs.

Size—Having both a horizontal and vertical projections system takes up space. At some schools, space is limited. For many horizontal projection systems, because the table and projector are provided as a unit, the footprint is quite large. A lot of classrooms will just not have the real estate in a classroom to dedicate to a large unit. The table top interactive projection system will not be used all day long, and is instead used for special activities, so it would not warrant a huge area in a classroom space.

Cost—Interactive projecting systems are still a “wish list” item for most schools, primarily because of cost. As long as the cost is as high as it is, the idea of having two interactive projection systems (one for horizontal and one for vertical display) is too expensive.

Fragile—Some tabletop systems using undermounted projection devices have a glass top or a clear exterior horizontal display surface which may break.

There are floor interactive display systems that are used primarily in marketing situations and retail. These use motion cameras to determine the location of the person interacting with the image. These systems are typically located in central, public areas and are used for games such as soccer, hockey, chasing animals, etc. These systems are very expensive and current applications have very little educational benefit to them. The activities associated with them are usually for use by a marketing person or are used to grab the attention of passer-bys.

There are multiple styles of teaching. Certain lessons/presentations would be better suited to alternative and untraditional solutions. The use of technology and interactive technology is still gaining in popularity in schools. Currently, interactive solutions are limited to one dimension—either vertical work surfaces (mobile carts for interactive boards, wall mounted interactive boards, etc) or horizontal work surfaces (interactive tables—Microsoft™ surface, SmartTable™, etc.). Schools wanting to use both methods of teaching/presenting and interaction need to buy multiple products, which can be very expensive.

In addition, various age groups benefit from and are most comfortable with different types of interaction. Small children are used to working on the floor or carpet, and spend a lot of their class time on the floor or carpet (small group time, whole class carpet teaching, etc), but the use of interactive display technology has not been brought to their level. Certain activities, like drawing, drafting, and animation, are often done at a table, where it is more comfortable to work with the medium. Presentations and demos are best suited to larger, vertical displays that the entire group can see at once.

The present invention allows three different surfaces to be used for teaching/presentations—the floor, the tabletop and the wall—all in one small and compact unit. Schools have limited budgets, and cannot afford to buy multiple pieces of equipment to suit varying needs throughout a school. This invention allows a school to purchase just one piece of equipment and achieve a range of set ups.

### BRIEF DESCRIPTION OF THE DRAWINGS

In drawings which illustrate by way of example embodiments of the invention:

FIG. 1 is a front perspective view of one embodiment of a mobile stand for mounting a projector for projection onto horizontal and vertical interactive surfaces according to the invention.

FIG. 2 is side plan view of the projector mounting assembly for the interactive mobile stand of FIG. 1, including a first plate, an inner tube, outer tube and tube, second plate and a spring button.

FIG. 3 is a side plan view of the first plate, inner tube and spring button of FIG. 2.

FIG. 4 is a front plan view of the first plate of FIG. 3.

FIG. 5 is a perspective view of the inner tube according of FIG. 3.

FIG. 6 is a perspective view of the second plate and outer tube of FIG. 2,

FIG. 7 is a front plan view of the second plate of FIG. 6.

FIG. 8 is a perspective view of the outer tube of FIG. 6.

FIG. 9 is a perspective view of the base of the mobile stand of FIG. 1.

FIG. 10 is a top plan view of the base of FIG. 9.

Similar references are used in different figures to denote similar components.

### DETAILED DESCRIPTION

The application relates to a compact, mobile stand to which an interactive projector is mounted to allow projection of various sized images on both vertical and horizontal surfaces to create interactive surfaces. The mobile stand comprises a base, a vertical frame and means for mounting the projector on the stand so that it is adjustable to move vertically and to be rotated through at least 90 degrees. The mobile stand is also provided with means to support a computer/lap top which connects with the projector. Using the apparatus of the invention, a user can project an image on a wall (vertical surface) or on a floor/table (horizontal surface). The small and compact size of the unit make it very easy for one person to move the apparatus throughout any location.

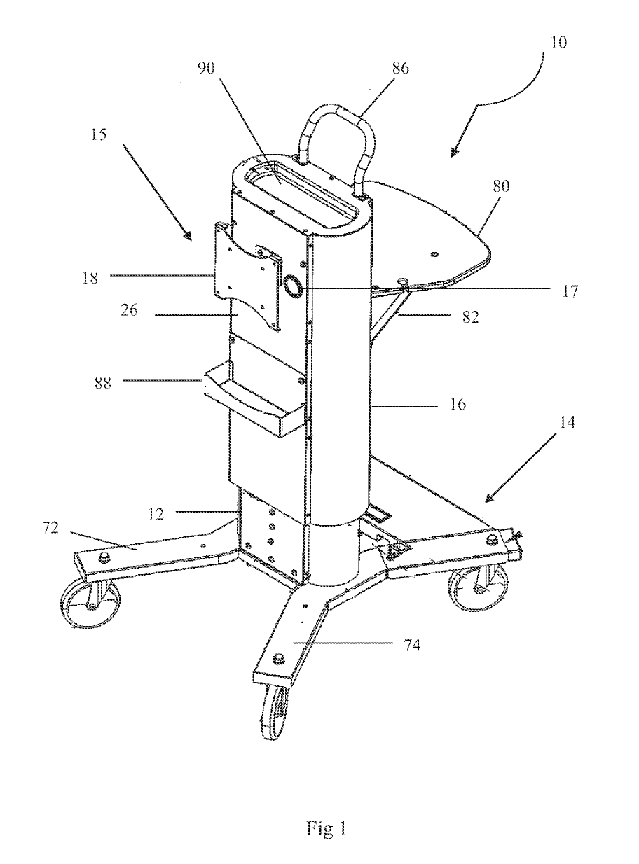

Referring now to the figures in detail, in FIG. 1, one embodiment of a mobile stand, generally indicated at 10, according to the present invention is illustrated.

The mobile stand 10 has a vertical frame comprising an inner column 12 mounted on a base, generally indicated as 14. In the embodiment illustrated the means for mounting the projector (not shown) on the stand so that it is adjustable to move vertically and to be rotated through at least 90 degrees comprises an outer column 16 surrounding inner column 12 and a projector mounting assembly generally indicated at 15 mounted to the outer column 16. The outer column 16 may slide up and down on inner column 12 to permit adjustment of the height of the projector mounted to the mobile stand relative to a horizontal or vertical surface on which the projector is to display an image. The height of the column can be adjusted and controlled using a mechanism similar to a standard drawer slide (for example as used on a desk drawer) and a gas cylinder. The gas cylinder supplies the force required to lift the outer column, and limits the range it can adjust such that the column can only travel as long as the shaft on the cylinder. The drawe slides help the unit to glide evenly, along a track, and help to reduce any binding and twist on the column.

The use of gas springs or other compressible spring means permits a teacher to move the outer column 16 from a vertical position to a lower vertical position. The gas springs allow for easy, effortless movement. A lift handle 86 allows for activation of the springs and thus, movement of the outer column 16 relative to the inner column 12. The gas cylinder adjusts the height of the unit, with a release cable being in the side of the unit. In one embodiment, the projector can be moved vertically a distance of 12-14 inches, from a fully extended height of 53 inches to a height of 41 inches, not including the handle, when not extended. This allows the projector to be used on horizontal surfaces at different heights.

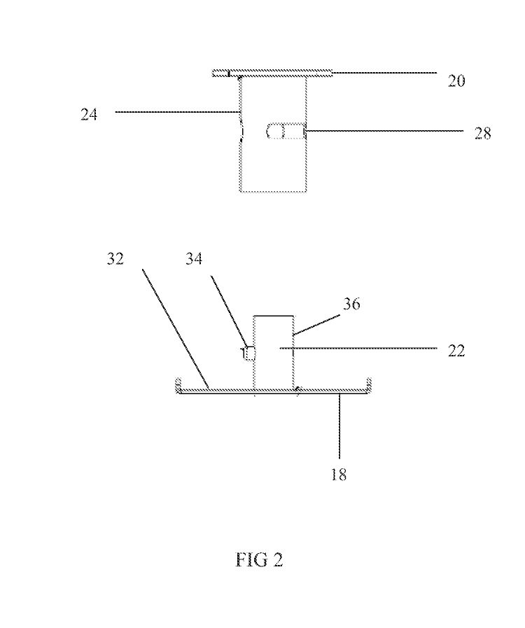

As best shown in FIG. 2-8, the projector mounting assembly 15 comprises a first plate 18, a second plate 20, a pair of tubes, inner tube 22 and outer tube 24. Second plate 20 is affixed, as shown in FIG. 1, to the outer surface 26 of outer column 16. The outer tube is affixed (by welding or other suitable means) to plate 20 so that outer tube 24 extends outwardly away from the outer surface 26 of column 16, preferably perpendicular to column 16. Outer tube 24 has at least two holes 28,30 spaced 90 degrees apart around the periphery of outer tube 24. The inner tube 22 is affixed (by welding or other suitable means) to the back surface 32 of plate 18 so that inner tube 22 extends inwardly, preferably perpendicular to plate 18. Inner tube 22 and outer tube 24 are dimensioned so inner tube 22 can be inserted into outer tube 24. A spring button 34 on the outer surface 36 of inner tube 22 is positioned to snap into hole 28 or 30 as the inner tube 22 and attached plate 18 are rotated through 90 degrees.

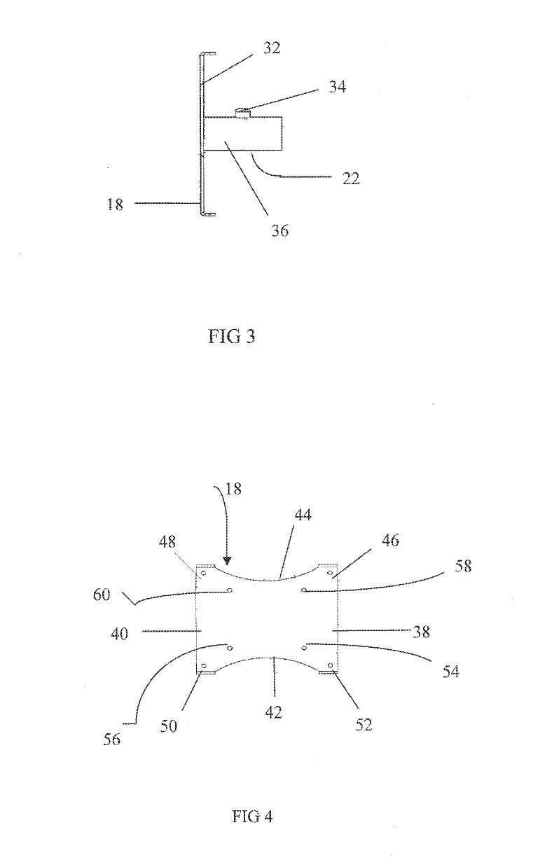

As shown in FIG. 4, the first plate 18 to which the interactive projector may be affixed, is substantially square, with two opposite straight edges, 38, 40 and two opposite edges 42, 44 that curve inward toward the centre of the plate. The plate 18 has four apertures, 46, 48, 50 and 52 through which the projector may be mounted to the plate. A second set of holes 54, 56, 58 and 60 are located on the plate to accommodate different brands of projectors.

FIG. 5 shows the inner tube 22 comprising a hollow cylinder with aperture 52 through which spring button 34 is attached.

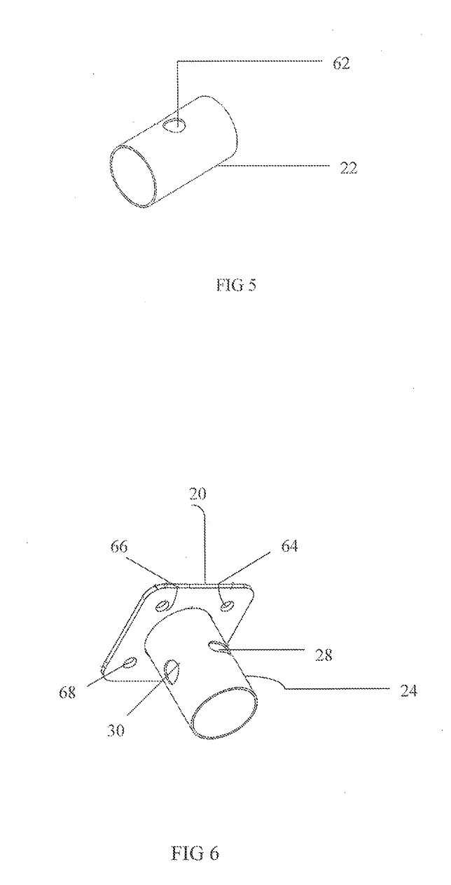

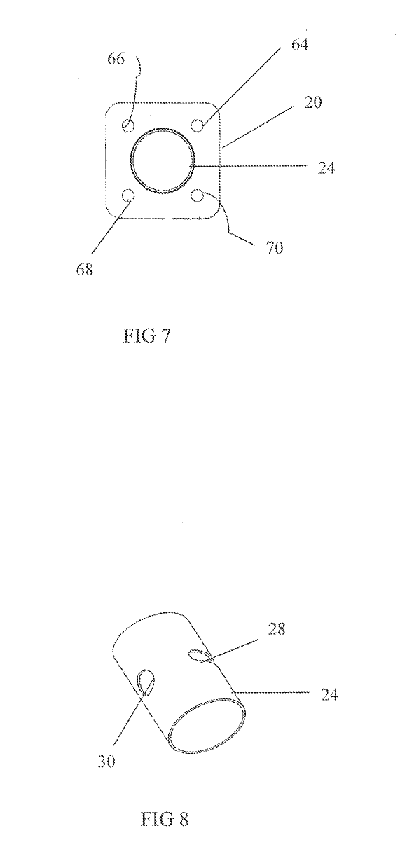

FIG. 6 shows second plate 20 and outer tube 24 affixed to it. The plate 20, see FIG. 7, is substantially square with four apertures 64, 66, 68 and 70 that permit it to be attached by suitable fasteners to outer column 16. Outer tube 24 extends perpendicular to plate 20 and is preferably positioned in the centre of the plate. Outer tube 24 is secured to plate 20 by welding or other suitable means. The plate 20 is affixed to the outer column 16. The outer tube 24, see FIG. 8 is a hollow cylinder of larger diameter than the inner tube 22 and has at least two apertures, two 28 and 30, positioned 90 degrees apart. The outer tube 24 is positioned over the inner tube 22 so that the inner tube 22 can be rotated from a vertical projecting position to a horizontal projecting position. Spring button 34 on inner tube 22 is aligned with one of the apertures 28, 30 on the outer tube 24. When the spring button 34 is depressed/released, the inner tube 22 can rotate until the inner tube 22 can be aligned with a second aperture 30 on the outer tube 24. In this way, a projector can be moved from a position where the interactive display image would be projected onto a table top or a floor to a second position where the interactive display would be projected onto a wall or other vertical surface.

The base 14 should be able to support the weight of the frame with the projector attached, and must be able to allow the column to remain balanced when both a computer and a projector are mounted on the column.

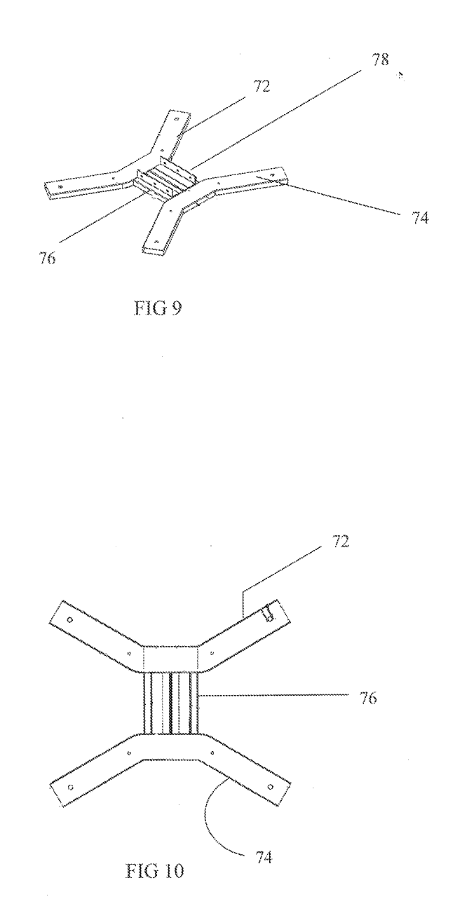

In the embodiment illustrated, the base 14 comprises two bent feet 72 and 74 joined by one or more stretchers 76. Each foot has a straight central portion with the end portions of each foot bent outward at an approximately 45 degree angle from the longitudinal axis of the straight portion of the bent feet. The two bent feet may be connected to each other along their straight portion by one or more stretchers 76. As shown in FIG. 9, one or more mounting brackets 78 may be attached to the stretchers. The bottom of inner column 12 would be affixed to the base 14 by mounting brackets 78.

The mobile stand 10 shown in the drawings also has means for supporting a computer, in this embodiment comprising a tray 80 extending outward from the outer column 16, perpendicular to the vertical axis of the column. The tray 80 is supported by support braces 84 which extends downward from the sides of the tray to the outer column at an approximate 45 degree angle. There is a hole 17 in the column through which the cables of the computer and other wiring of the projector can be passed. The mobile stand 10 also has a handle 86 located at the top of column that allows for easy movement of the mobile stand.

Numerous accessories can be utilized with the mobile stand of the present invention, For example in FIG. 1, an optional storage bin 88 is affixed to the outer column 16 below the projector mounting assembly 15, although the bin could be located anywhere on the stand as long as it does not interfere with the movement or operation of the projector. Another optional storage area 90 may be located in the top of column 16.

Various modifications to the design shown in the Figures are possible. For example the means for holding the computer may be located at the top of the base of the stand, with optional storage trays at the rear of the stand. The storage trays can be parallel to each other and extend upward at an approximately 45 to 60 degree angle from the vertical axis of the stand.

The base may include a covered storage bin extending between the front of the two bent feet 72 and 74. The storage bin can be used to store a power bar and cables. For example, cables may be routed through the unit and out of the bottom of the stand. The base may include a hook for storage of the power cord. The wheels on the base may be capable of locking into position to prevent movement of the stand.

There may also be a bottom shelf bolted between the rear of the two bent feet 72 and 74. The shelf may support a standing CPU tower. Ledges extending from the inner side of each bent foot may be provided. The ledges face each other so as to form a support for the shelf. The shelf may be attached to the ledges by one or more bolts.

Alternative designs for the base from what is shown in the attached drawings are possible. For example in one alternative the base can comprises an elliptical hoop. Straight stretchers can extend across the diameter of the ellipse with casters positioned so that a line drawn between the four casters would form a box surrounding the central column.

The stand is designed to be mobile. Small size improves the mobility. In one embodiment, the size of the mobile stand is 13.6 inches by 7.75 inches by either 53 inches (extended position) or 41 inches (compressed position). The base of the stand measures 26 by 29 inches. Other dimensions are possible.

The invention addresses some of the issues described above with known devices. Some features of the interactive projector detachable mounting apparatus for horizontal display surfaces are as follows:

Cost effective solution—compared to alternative interactive solutions currently on the market there is a significant cost advantage to the mobile stand. Currently users must invest in multiple products for different kinds of projection (horizontal vs. vertical), but with this invention they can invest in one solution and have three projection options.

Sharing/Portability—Because of both the unit's small and compact size and the casters, the unit can be quickly moved to another location. This allows schools to try and share technology throughout a school, to provide technology to a wider range of users while staying within tight budgets, and make use of various teaching locations in the school (alternative solutions are hard to move and/or do not always fit through internal corridors easily).

Software Agnostic—alternative devices to this often work with only included software. The benefit of using an interactive projector is that it works with a range of software the user may have access to, including the use of whatever software is installed on the computer.

Simplicity—once the unit is set up the teacher only has to turn the unit on to begin using it. No class time is wasted with lengthy set up times and processes.

Flexibility—the interactive mobile stand allows for multiple styles of teaching and learning all in one unit. One unit is capable of three different set ups so the unit can replace multiple other units.

Image Size—the image size can be adjusted. Depending on the set up, users can have access to 96″ diagonal images (floor/horizontal; wall/vertical) to 50″ diagonal images (table/horizontal).

One handed height adjustment—through the use of a gas cylinder and simple release mechanism the use can adjust the height of the projector a range of 12″+ with one hand. The adjustment in height allows the user to experience various image sizes.

Universal—the ability to mount any brand of interactive projector.

As is evident from the foregoing description, certain aspects of the present invention are not limited by the particular details of the mobile stand illustrated in the drawings. Other modifications and applications, or equivalents, will occur to those skilled in the art. The terms “having”, “comprising” and “including” and similar terms as used in the foregoing specification are used in the sense of “optional” or “may include” and not as “required”. Many changes, modifications, variations and other uses and applications of the present construction will, however, become apparent to those skilled in the art after considering the specification and attached drawings. All such changes, modifications, variations and other uses and applications which do not depart from the spirit and scope of the invention are deemed to be covered by the invention which is limited only by the claims that follow. The scope of the disclosure is not intended to be limited to the embodiments shown herein, but is to be accorded the full scope consistent with the claims, wherein reference to an element in the singular is not intended to mean “one and only one” unless specifically so stated, but rather one or more. All structural and functional equivalents to the elements of the embodiment described throughout the disclosure that are known or later come to be known to those of ordinary skill in the art are expressly incorporated herein by reference and intended to be encompassed by the claims.

1. A mobile stand to which an interactive projector is mounted to allow projection of various sized images on both vertical and horizontal surfaces to create interactive surfaces, the mobile stand comprising a base, a vertical frame, means for mounting the projector on the vertical frame so that it is adjustable to move vertically and to be rotated through at least 90 degrees and means to support a computer/lap top which connects with the projector.

2. The mobile stand of claim 1 wherein the vertical frame has an inner column and the means for mounting the projector on the stand is an outer column surrounding the inner column and a projector mounting assembly mounted to the outer column.

3. The mobile stand of claim 2 wherein the outer column may slide up and down on inner column to permit adjustment of the height of the projector mounted to the mobile stand relative to a horizontal or vertical surface on which the projector is to display an image.

4. The mobile stand of claim 2 wherein the projector mounting assembly comprises a first plate to which a projector may be attached, a second plate affixed to an outer surface of outer column, an inner tube affixed to the first plate and extending inwardly from the first plate, an outer tube affixed to the second plate and extending outwardly therefrom, wherein the inner and outer tubes are dimensioned so that one tube can rotate around the other tube so that the first plate can be moved through at least 90 degrees and means for locking the first plate in position.

5. The mobile stand of claim 4 wherein the rotation of the inner and outer rotational tubes relative to each other allows the projector to move from an orientation where it is capable of projecting an image on a horizontal surface to an orientation where it is capable of projecting an image on a vertical surface.

6. The mobile stand of claim 5 wherein means on the inner tube can be aligned with one of at least two apertures on the outer tube said apertures spaced apart by 90 degrees.
